(19) United States
(12) Patent Application Publication
(10) Pub. No.: US 2014/0321771 A1
(43) Pub. Date: Oct. 30, 2014

(54) TECHNIQUES FOR REAL-TIME CLEARING AND REPLACEMENT OF OBJECTS

(71) Applicant: QUALCOMM Incorporated, San Diego, CA (US)

(72) Inventors: Georg REINISCH, Graz (AT); Clemens Arth, Judendorf-Strassengel (AT)

(73) Assignee: QUALCOMM Incorporated, San Diego, CA (US)

(21) Appl. No.: 14/256,812

(22) Filed: Apr. 18, 2014

Related U.S. Application Data
(60) Provisional application No. 61/815,694, filed on Apr. 24, 2013.

(51) Int. Cl. G06T 11/60

(52) U.S. Cl. CPC G06T 11/60
USPC 382/284

(57) ABSTRACT

A real-time panoramic mapping process is presented for generating a panoramic image from a plurality of image frames that are being captured by one or more cameras of a device. The proposed mapping process may be used to clear-out an unwanted portion from the panoramic image and replace it with correct information from other images of the same scene. Moreover, brightness seams may be blended while constructing the panoramic image. The proposed real-time panoramic mapping process may be performed on a parallel processor.

### CROSS-REFERENCE TO RELATED APPLICATIONS

The present application for patent claims priority to Provisional Application No. 61/815,694 entitled “A Method for Real-Time Wiping and Replacement of Objects” filed Apr. 24, 2013, and assigned to the assignee hereof and hereby expressly incorporated by reference herein.

### TECHNICAL FIELD

The present disclosure relates generally to a mobile device, and more particularly, to a method for real-time clearing and replacement of objects within a panoramic image captured by a mobile device and panoramic mapping on a processor of a mobile device.

### BACKGROUND

The creation of panoramic images in real-time is typically a resource-intensive operation for mobile devices. Specifically, mapping of the individual pixels into the panoramic image is one of the most resource intensive operations. As an example, in the field of augmented reality, methods exist for capturing an image with a camera of a mobile device and mapping the image onto the panoramic image by taking the camera live preview feed as an input and continuously extending the panoramic image, while the rotation parameters of the camera motion are estimated. However, these mapping techniques can only handle images having low resolutions. Larger resolution images result in significant performance degradation in the rendering speed of the mapping process. Other known approaches either do not run in real-time on mobile devices or cannot remove artifacts such as ghosting or brightness seams or unwanted objects from the image. Therefore, there is a need for methods to efficiently construct panoramic images while capturing multiple images on a mobile device.

### SUMMARY

These problems and others may be solved according to various embodiments, described herein.

A method for real-time processing of images includes, in part, constructing a panoramic image from a plurality of image frames while the plurality of image frames are being captured by at least one camera of a device, identifying an area comprising unwanted portion of the panoramic image, replacing a first set of pixels in the identified area with a second set of pixels from one or more of the plurality of image frames, and storing the panoramic image in a memory

In one embodiment, replacing the first set of pixels in the panoramic image includes, in part, clearing the area in the panoramic image comprising the first set of pixels, marking the area as unmapped within the panoramic image, and replacing the unmapped area with the second set of pixels.

In one embodiment, analyzing the panoramic image includes executing a face detection algorithm on the panoramic image. In one embodiment, identifying and replacing steps are performed in real-time during construction of the panoramic image from the plurality of image frames.

In one embodiment, the panoramic image is constructed in a graphics processing unit. In one embodiment, the method further includes correcting brightness offset of a plurality of pixels in the panoramic image while constructing the panoramic image. For example, the brightness offset is corrected by defining an inner frame and an outer frame in the panoramic image, and blending the plurality of pixels that are located between the inner frame and the outer frame.

Certain embodiments present an apparatus for real-time processing of images. The apparatus includes, in part, means for constructing a panoramic image from a plurality of image frames while the plurality of image frames are being captured by at least one camera of a device, means for identifying an area comprising unwanted portion of the panoramic image, means for replacing a first set of pixels in the identified area with a second set of pixels from one or more of the plurality of image frames, and means for storing the panoramic image in a memory.

Certain embodiments present an apparatus for real-time processing of images. The apparatus includes at least one processor and a memory coupled to the at least one processor. The at least one processor is configured to construct a panoramic image from a plurality of image frames while the plurality of image frames are being captured by at least one camera of a device, identify an area comprising unwanted portion of the panoramic image, replace a first set of pixels in the identified area with a second set of pixels from one or more of the plurality of image frames, and store the panoramic image in a memory, wherein the memory is coupled to the at least one processor.

### BRIEF DESCRIPTION OF THE DRAWINGS

Aspects of the disclosure are illustrated by way of example. In the accompanying figures, like reference numbers indicate similar elements, and:

FIG. 1 illustrates an example projection of a camera image on a cylindrical map, in accordance with certain embodiments of the present disclosure.

FIG. 2 is a flowchart illustrating an exemplary method of constructing a panoramic image and clearing and replacing objects within the panoramic image, in accordance with certain embodiments of the present disclosure.

FIG. 3 illustrates an example of clearing of objects within a panoramic image, in accordance with certain embodiments of the present disclosure.

FIG. 4 illustrates an example optimized mapping area determined by panoramic mapping using a parallel processor, in accordance with certain embodiments of the present disclosure.

FIG. 5 illustrates another example mapping area determined by panoramic mapping, in which an additional optimization approach does not save on computation costs, in accordance with certain embodiments of the present disclosure.

FIG. 6 illustrates an example scenario in which the camera image is linearly blended with the panoramic image in the frame area between the outer and inner blending frame, in accordance with certain embodiments of the present disclosure.

FIG. 7 illustrates example rendering speeds for three devices for the proposed panoramic mapping process for low-resolution and high-resolution panoramic images, in accordance with certain embodiments of the present disclosure.

FIG. 8 illustrates an example of a computing system in which one or more embodiments may be implemented.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Embodiments of the invention relate generally to a mobile device, and more particularly, to a method for real-time construction of a panoramic image from a plurality of images captured by a mobile device. In addition, the method may include clearing and replacement of objects within the panoramic image and panoramic mapping using a parallel processor such as graphics processing unit (GPU) of a mobile device. Using a parallel processor for real-time mapping allows for parallel processing of pixels and improved image quality. Usually, pixels that are projected on the panoramic image are independent, and hence, a suitable candidate for parallel processing. Further, the ability to wipe and replace objects within the panoramic image in real-time enables a user to capture and revise panoramic pictures in real-time until the result is satisfactory, which may increase user-friendliness of the system.

Generally speaking, a parallel processor such as a GPU may accelerate generation of images in a frame buffer that may be intended for output to a display. Special structure of the parallel processors makes them suitable for processing large blocks of data in parallel. Parallel processors may be used in a variety of systems such as embedded systems, mobile phones, personal computers, workstations, game consoles, and the like. Embodiments of the present disclosure may be performed using different kinds of processors (e.g., a parallel processor such as a GPU, a processor with limited parallel paths (e.g., a CPU), or any other processor with two or more parallel paths for processing data.) However, as the number of parallel paths increases in a processor, the proposed methods may be performed faster and more efficiently. In the rest of this document, for ease of explanation, it is referred to a GPU as an example of a parallel processor. However, these references are not limiting and may mean any type of processors.

Embodiments of the present invention may perform panoramic mapping, clearing, and/or orientation tracking on the same data set on a device in real-time. Several techniques exists in the art for tracking orientation of a camera. These methods may be used to extract feature points, perform image tracking and estimate location of the current camera image for the mapping process. Most of these techniques may be used for post-processing the images (e.g., after the images are captured and saved into the device). Hence, they need large amounts of memory to save all the individual image frames that can be used in a later time to construct the panoramic image.

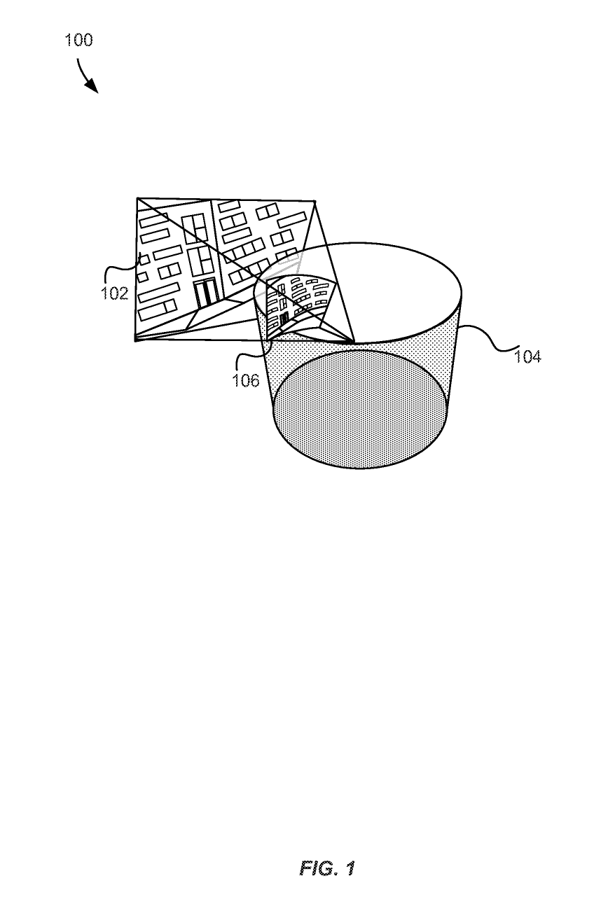

For panoramic mapping, a cylinder or any other surface may be chosen as a mapping surface (as illustrated in FIG. 1). Without loss of generality, in the remainder of this document a cylinder is used as a mapping surface. However, any other mapping surface may also be used without departing from teachings of the present disclosure. The panoramic map may be divided into a regular grid (e.g., 32×8 cells) to simplify handling of an unfinished map. During the mapping process, each cell may be filled with mapped pixels. When all the pixels of a cell are mapped, the cell may be marked as complete.

FIG. 1 illustrates an example projection of an image on a cylindrical map. As illustrated, an image 102 is mapped on a cylinder 104 to generate a projected image 106. For mapping the camera image onto the cylinder, pure rotational movements may be assumed. Therefore, three degrees of freedom (DOF) can be used to estimate a projection of the camera image. A rotation matrix calculated by a tracker may be used to project the camera frame onto the map. Coordinates of corner pixels of the camera image are forward-mapped into the map space. The area covered by the frame (e.g., the projected image 106) represents the estimated location of the new camera image.

It should be noted that forward-mapping the pixels from the camera frame to the estimated location on the cylinder can cause artifacts. Therefore, data of the camera pixel can be reverse-mapped. Even though the mapped camera frame represents an almost pixel-accurate mask, pixel holes or overdrawing of pixels can occur. However, mapping each pixel of the projection may generate a calculation overload. For certain aspects, the computations may be reduced by focusing the mapping area to the newly-mapped pixels (e.g., the pixels for which panoramic image data is not available.)

For certain embodiments, the panoramic mapping process may be divided into multiple parallel paths, which can be calculated in parallel on a parallel processor (such as a GPU). Each individual pixel of an image can be mapped independently. Therefore, most of the calculations for mapping the pixels can be performed in parallel. For example, a shader program on a GPU may be used to process the panoramic image. A shader program is generally used to generate shading (e.g., appropriate levels of light and color within an image) on pixels of an image. Re-using the shader program for image processing enables efficient processing of the images, which may be costly to perform on processors with limited parallel processing paths. It should be noted that in the rest of this disclosure, it is referred to a shader program for parallel processing of the panoramic image. However, any other parallel processing hardware or software block may be used instead of the shader program without departing from teachings of the present disclosure. As a non-limiting example, panoramic mapping and image refinement methods (such as pixel blending and/or clearing certain areas) may be performed by the fragment shader on a GPU.

### Real-Time Clearing and Replacement of Objects

Certain embodiments propose real-time clearing and replacement of an object in a panoramic image while the image is being captured and recorded. The proposed clearing features may be performed along with the panoramic mapping process. Using a mapping approach that runs on a parallel processor may enable new features (such as clearing areas in the panoramic image in real-time) to be added to a device.

A panoramic image may contain unwanted areas such as people or cars blocking an essential part of the scene. To remove these unwanted areas, the panoramic image can be edited in real-time as described herein. For example, a user may wipe over one or more sections of a panoramic image preview that is displayed on the screen of a mobile phone. For certain embodiments, coordinates of the sections specified by the user might be passed to the shader program for processing. The shader program may clear the region corresponding to the input coordinates and mark the area as unmapped. These cleared areas may be mapped again using a new frame of the scene. For example, pixels corresponding to the cleared areas may be filled with color information from the new frame.

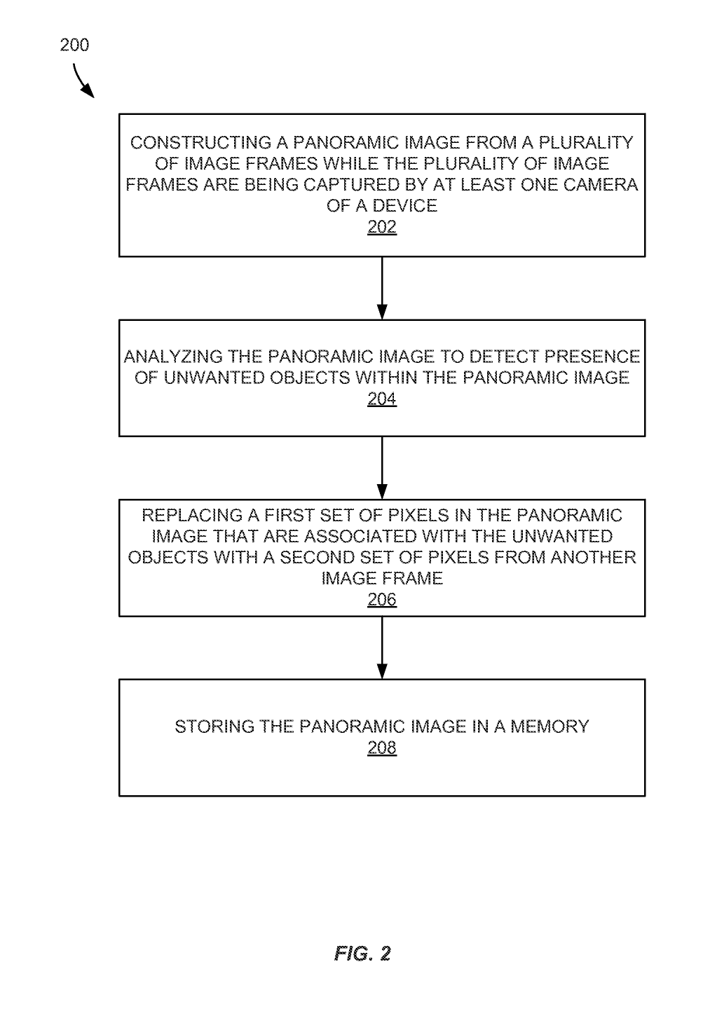

FIG. 2 is a flowchart 200 illustrating an exemplary method 200 of constructing a panoramic image in real-time. In step 202, the panoramic image may be constructed from a plurality of image frames while the plurality of image frames are being captured by at least one camera of a device. In one embodiment, the device may be a mobile device or any other portable device.

In step 204, an area including unwanted portion of the panoramic image is identified. In one embodiment, the panoramic image may be analyzed to identify unwanted objects within the panoramic image. In some embodiments, the analyzing includes executing a face detection algorithm on the device. The face detection algorithm may detect presence of faces within the panoramic image. For example, a user may be interested to take a panoramic image of a scene and not a person or a group of people that may block part of the scene. As such, the face detection algorithm may specify detected faces within the panoramic image as unwanted objects.

In another embodiment, an object detection algorithm may be executed on the device. Similar to the face detection algorithm, the object detection algorithm may detect unwanted objects within the panoramic image. In some embodiments, the criteria for object detection may be defined in advance. For example, one or more parameters representing the unwanted object (such as shape, size, color, etc.) may be defined for the object detection algorithm.

In some embodiments, the unwanted objects/and/or unwanted portions of the panoramic image may be identified by a user of the device. For example, the user may select unwanted portions of the image on a screen. The user may indicate the unwanted sections and/or objects by swiping on the touch-screen of a mobile device or using any other method to indicate the unwanted objects.

In step 206, a first set of pixels in the panoramic image that are associated with the unwanted section may be replaced with a second set of pixels from one or more of the plurality of image frames. In one embodiment, an area including the first set of pixels associated with the unwanted objects within the panoramic image may be cleared. The cleared area within the panoramic image may be marked as unmapped. In one embodiment, the area may be defined by a circle having a radius. The area may be calculated using a function of a current fragment coordinate, a marked clearing coordinate, and the radius, as will be described later. By marking the area as unmapped, the area will be remapped with new pixel data within the panoramic image. For example, the unmapped area may be replaced with the second set of pixels. Assuming that the other image frame does not include the originally detected unwanted objects, replacing the unmapped area with the second set of pixels from one or more of the plurality of image frames will result in the panoramic image being free of the detected unwanted objects. In step 208, the panoramic image may be stored in a memory of the device.

As described above with respect to FIG. 2, the identifying, clearing, marking and replacing steps may be performed in real-time during construction of the panoramic image, and possibly before storing the panoramic image. In one embodiment, these processes may be performed on a parallel processor such as a GPU. The steps provided above eliminates the need to store each of the individual images that are used in constructing the panoramic image. Hence, reducing the amount of memory needed in the panoramic image construction process and improving image construction performance. The proposed method may be used to generate high resolution panoramic images. It should be noted that although the proposed method reduces/eliminates a need for storing each of the individual frames, one or more of these frames may be stored along with the panoramic image without departing from teachings of the present disclosure.

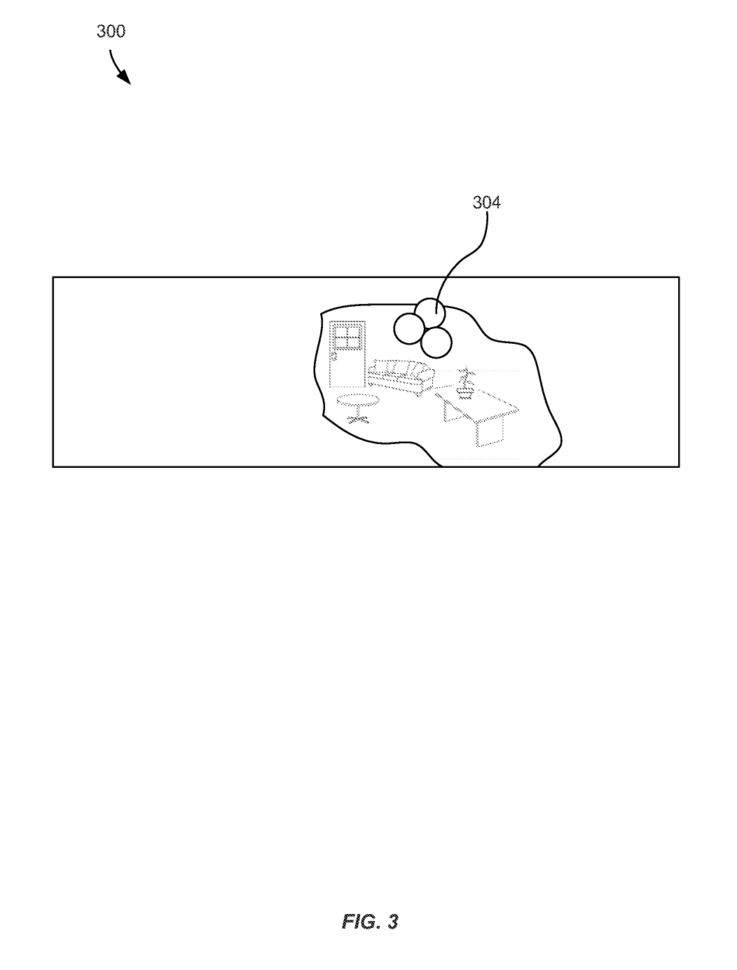

FIG. 3 illustrates clearing one or more objects within a panoramic image, in accordance with certain embodiments of the present disclosure. As illustrated, area 304 can be removed and/or cleared from a panoramic image 300. In general, area 304 may include one or more unwanted objects. It should be noted that the area may be selected as an approximation of the unwanted objects. Therefore, the area may include multiple other pixels (e.g., in the neighborhood of the objects) that are not part of the unwanted objects. In some embodiments, a possible implementation of the clearing feature may be a simple wipe operation on a touch screen, in which a user selects coordinates of an area to be cleared using the touch screen. In one embodiment, the area around one or more coordinates that are marked to be cleared may be defined to be circular (as shown in FIG. 3) with a radius of N pixels. In another embodiment, the area may have any shape other than a circle. The program may pass the coordinates to the fragment shader. The shader program may calculate the clearing area using dot product of the Euclidean distance between the current fragment coordinate \vec{t} and the marked coordinates \vec{w} that are being cleared, as follows:

(\vec{t}−\vec{w})·(\vec{t}−\vec{w})<(N²)

If the condition is true and the marked coordinate lies within the Euclidean distance, the pixel that is currently processed by the fragment shader is cleared. As described earlier, the cleared pixel may then be re-mapped from another frame. Using a parallel processor in the mapping process allows clearing and re-mapping of the image to be performed in real-time while the picture is being captured.

For certain embodiments, a render-to-texture approach using two frame buffers and a common method known as the “ping-pong technique” may be used to extract information about the current panoramic image. This information may be used in processing of the panoramic image (e.g., pixel blending). In addition, a vertex shader may be used to map the panoramic texture coordinates on respective vertices of a plane. The texture coordinates between the vertices may be interpolated and passed on to a fragment shader. The fragment shader may manipulate each fragment and store the results in the framebuffer. In addition, color values for each fragment may be determined in the fragment shader. The panoramic mapping as described herein, uses current camera image, coordinates of the set of pixels that are being processed, and information regarding orientation of the camera to update the current panoramic image.

For certain embodiments, every pixel of the panoramic image may be mapped separately by executing the shader program. The shader program determines whether or not a pixel of the panoramic image lies in the area where the camera image is projected. If the pixel lies in the projected area, color of the respective pixel of the camera image is stored for the pixel of the panoramic image. Otherwise, the corresponding pixel of the input texture may be copied to the panoramic image.

For certain embodiments, the fragment shader program (which may be executed on all the pixels of the image) may be optimized to reduce the amount computations performed in the mapping process. For example, information that does not vary across separate fragments may be analyzed outside of the fragment shader. This information may include resolution of the panoramic image, texture and resolution of the camera image, the rotation matrix, ray direction, the projection matrix, the angular resolution, and the like. By calculating this information outside of the fragment shader and passing them along to the fragment shader, the mapping calculations may be performed more efficiently.

For certain embodiments, a cylindrical model placed at the origin (0,0,0) may be used in the mapping procedure to calculate the angular resolution. The radius r of the cylinder may be set to one; therefore, the circumference C may be equal to 2·π. Ratio of the horizontal and vertical sizes may be selected arbitrarily. In some embodiments, a four to one ratio may be used. In addition, height h of the cylinder may be set to h=π/2. As a result, angular resolutions for the x and y coordinates may be calculated as follows:

$$a = \frac{c}{W} , b = \frac{h}{H} \qquad ( Eqn . 1 )$$

where a represents the angular resolution for the x-coordinate, h represents the angular resolution for the y-coordinate, C represents the circumference, W represents panoramic texture width, h represents the cylinder height, and H represents the panoramic texture.

In one example, each pixel of the panoramic map may be transformed into a three dimensional vector originating from the camera center of the cylinder (0,0,0). A ray direction may be considered as a vector pointing in the direction of the camera orientation. A rotation matrix R, which defines rotation of the camera, may be used to calculate the ray direction \vec{r}. The rotation matrix may be calculated externally in the tracking process during render cycles. A direction vector \vec{d} may, in one embodiment, point along the z-axis. Transpose of the rotation matrix may be multiplied with the direction vector to calculate the ray direction, as follows:

\vec{r}=R^{T}\vec{d} (Eqn. 2)

For calculation of the projection matrix P, a calibration matrix K (that may be generated in an initialization step), the rotation matrix R (that may be calculated in the tracking process) and the camera location \vec{t} may be used. If the camera is located in the center of the cylinder (\vec{t}(0,0,0)), calculating P can be simplified by multiplying K by R.

After preparing this information, the data may be sent to the fragment shader. Coordinates of the input/output textures u and r (that may be used for framebuffer-switching) may be acquired from the vertex shader. In general, vertex shaders are run once for each vertex (a point in 2D or 3D space) given to a processor. The purpose is to transform each vertex's three-dimensional (3D) position in virtual space to a two-dimensional coordinate at which it appears on the screen, in addition to a depth value. Vertex shaders may be able to manipulate properties such as position, color and texture coordinates.

In the fragment shader, each fragment (e.g. pixel) may be mapped into cylinder space and checked if the fragment falls into the camera image (e.g., reverse-mapping). The cylinder coordinates \vec{c}(x,y,z) may be calculated as follows:

cₓ=sin(ua),c_{y}=vb,c_{z}=cos(ua) (Eqn. 3)

where a and b are the angular resolutions as given in Eqn. 1.

In general, when projecting a camera image on a cylinder, the image may once be projected on the front of the cylinder and once on the back of the cylinder. To avoid mapping the image twice, it can be checked whether the cylinder coordinates are in the front or back of the cylinder. For certain embodiments, the coordinates that lie in the back of the cylinder may be avoided.

The next step may be to calculate the image coordinates \vec{i}(x,y,z) in the camera space. Therefore, the projection matrix P may be multiplied with the 3D vector transformed from the cylinder coordinates. As mentioned herein, this may be possible, because the camera center may be positioned at (0,0,0) and each coordinate of the cylinder may be transformed into a 3D-vector.

iₓ=P_{0,0}cₓ+P_{0,1}c_{y}+P_{0,2}c_{z} (Eqn. 4)

i_{y}=P_{1,0}cₓ+P_{1,1}c_{y}+P_{1,2}c_{z} (Eqn. 5)

i_{z}=P_{2,0}cₓ+P_{2,1}c_{y}+P_{2,2}c_{z} (Eqn. 6)

Next, the homogenous coordinates may be converted into image coordinates to get an image point. After rounding the result to integer numbers, the coordinates may be checked to see if the coordinates fall into the camera image. If this test fails, color of the corresponding input texture coordinate may be copied to the current fragment. If the test succeeds, color of the corresponding camera texture coordinate may be copied to the current fragment.

Without optimizing the process, this procedure may be performed for all the fragments of the output texture. For a 2048×512 pixel texture resolution (e.g., about one million fragments), every operation that is performed in the shader is executed about one million times. Even if the shader program is stopped when a fragment does not fall into the camera image, values that are used in the checking process should still be calculated.

In general, while mapping a camera image into a panoramic image, only a small region of the panoramic image may be updated. Therefore, for certain embodiments, the shader program may only be executed on an area where the camera image is mapped and/or updated. To reduce size of this area, coordinates of the estimated camera frame (that may be calculated in the tracking process) may be used to create a camera bounding-box. To reduce computations, only the area that falls within the camera bounding-box may be selected and passed to the shader program. This reduces the maximum number of times that the shader program is executed.

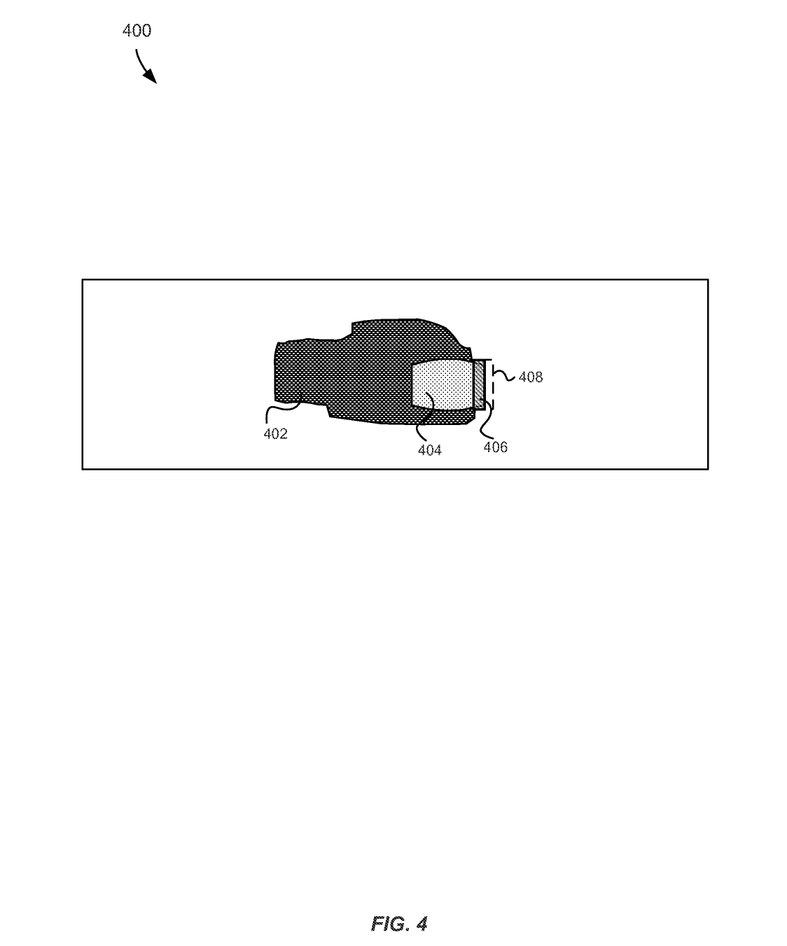

A second optimization step may be to focus only on newly-mapped fragments to further reduce the computational cost. This step may only map those fragments that were not mapped before. Assuming a panoramic image is tracked in real-time, and the frame does not move too fast, only a small area may be new in each frame. For certain embodiments, newly updated cells that are already calculated by the tracker may be used in the mapping process. In one example, each cell may consist of an area of 64×64 pixels. Without loss of generality, cells may have other sizes without departing from the teachings herein. If one or more cells are touched (e.g., updated) by the current tracking update, the coordinates may be used to calculate a cell bounding-box around these cells. In one embodiment, an area that includes the common area between the bounding-box of the camera image and the cell-bounding-box may be selected and passed to the shader as the new mapping area (e.g., as illustrated in FIG. 4).

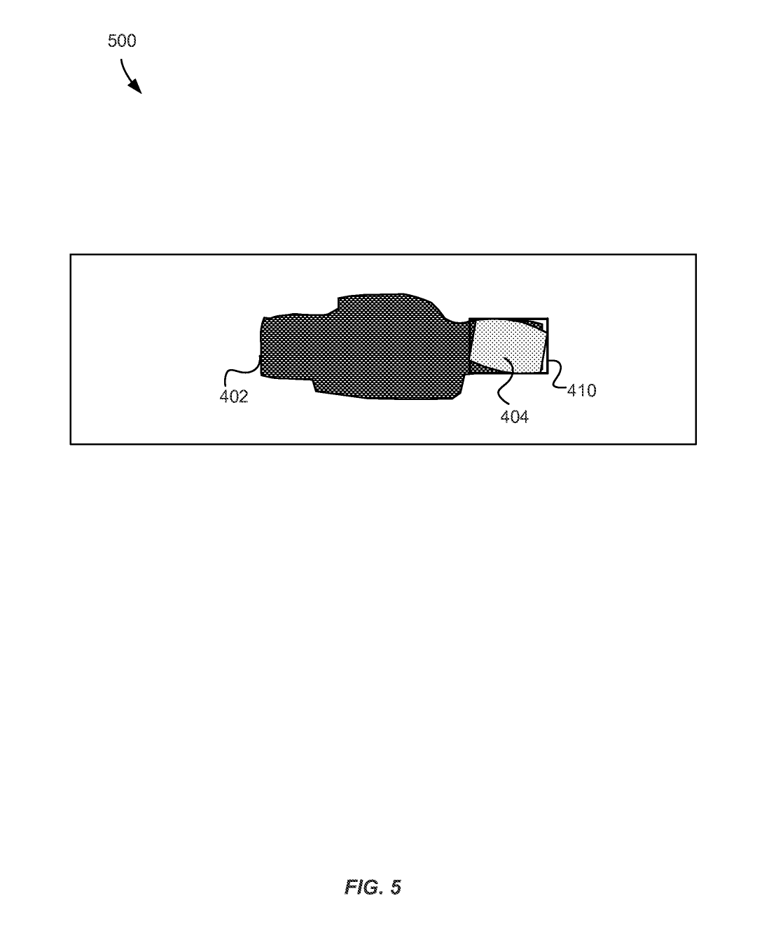

FIG. 4 illustrates a mapping area determined by panoramic mapping using a parallel processor. A current frame 404 is shown as a part of the mapped area 402. The camera bounding box corresponds to borders of the current frame 404. As described earlier, an update region 406 is selected to include the common area between the bounding box 404 of the camera image and cell bounding box 408. The update region 406 is passed to the shader for processing. As illustrated, parts of the camera image that are already mapped and remain unchanged in the current image are not updated. In this figure, by using a smaller area for update, computational costs is decreased. It should be noted that in some scenarios, employing this optimization step (e.g., mapping the fragments that were not previously mapped) may not reduce computational costs. The reason is that size of the bounding box directly depends on movement of the camera. For example, if camera moves diagonally compared to the panoramic image, as shown in FIG. 5, size of the cell bounding box increases.

FIG. 5 illustrates a mapping area determined by panoramic mapping using a parallel processor. In this figure the second optimization step, as described above, does not save on computation costs. As illustrated, in this scenario, a large update region 410 is passed to the shader program. Similar to FIG. 4, the update region 410 is selected to include the common area between the camera image and cell bounding box. This update region is larger than FIG. 4 because of rotation of the camera which resulted in diagonal movement within the panoramic space. A larger number of cells detected change, as a result, cell bounding box includes the whole image (e.g., cell bounding box is the same size as update region 410). Similarly, the updated area may become larger if the camera is rotated along the z-Axis. Note that in this example, the z-Axis is the viewing direction in the camera coordinate system. It can also be considered as the axis on which ‘depth’ is measured. Positive values on the z-Axis represent front of the camera and negative values on the z-Axis represent back of the camera. In this figure, size of the bounding-box cannot be reduced (because of the rotation) although the updated area is small.

Nevertheless, processing only the newly mapped areas can significantly reduce number of times the shader program is executed. Because in more frequent cases, only a small update area is selected (as shown in FIG. 4).

### Exposure Time

In general, during construction of a panoramic image from multiple images, sharp edges may appear in homogenous areas between earlier mapped regions and the newly mapped region due to diverging exposure time. For example, moving the camera towards a light source may reduce the exposure time, which may darken the input image. On the other hand, moving the camera away from the light source may brighten the input image in an unproportional way. Known approaches in the art that deal with the exposure problem do not map and track in real-time. These approaches need some pre-processing and/or post-processing on an image to remove the sharp edges and create a seamless panoramic image. Additionally, most of these approaches need large amounts of memory since they need to store multiple images and perform post-processing to remove the sharp edges from the panoramic image.

Certain embodiments of the present disclosure perform a mapping process, in which shading and blending effects may be directly employed at the time when the panoramic image is recorded. Therefore, individual images (that are used in generating the panoramic image) and their respective information do not need to be stored on the device. Using the attributes of a parallel processor such as a GPU, the post-processing steps for removing exposure artifacts can be eliminated. Instead, for certain embodiment, exposure artifact removal may become an active part of the real-time capturing and/or processing of the panoramic image.

### Brightness Offset Correction

In some embodiments, in order to correct the differences in brightness values of the current camera image, matching points may be found in the panoramic image and the camera image. Then, the brightness difference of these matching points may be calculated from the color data. The average offset of these brightness differences may then be forwarded to the shader program and be considered in the mapping process.

Existing implementations in the art calculate the brightness offset for multiple feature points within the panoramic image that are found by the tracker. However, best areas for comparing brightness are homogenous regions rather than corners. Certain embodiments of the present disclosure propose brightness offset correction on homogeneous regions of the image. One advantage of the proposed approach is that it can be performed with minimal computational overhead, since the tracker inherently provides the matches and the actual pixel values are compared.

### Pixel Blending

Blending the camera image with the panoramic image during the mapping process may be used to smoothen sharp transitions of different brightness values. To achieve smoother transitions, different blending approaches are possible. However, a frame-based blending approach may result in the best optically continuous image.

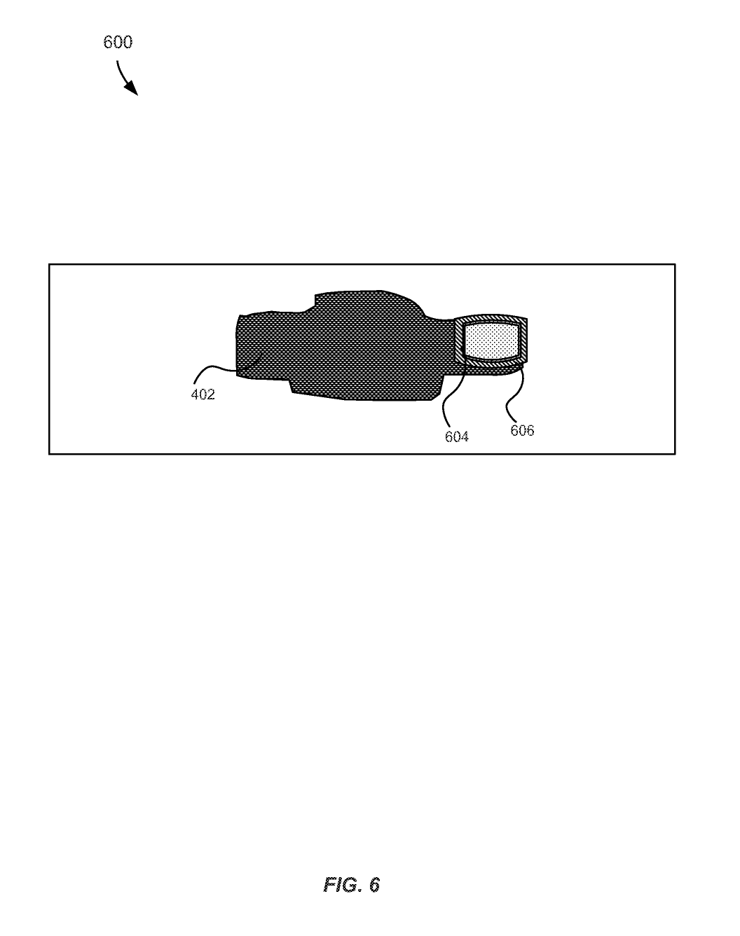

Since a camera image covers only a portion of the panoramic map, there is no need to blend every pixel of the panoramic map. Color values of newly mapped pixels can be drawn as they appear in the camera image or they would be blended with the initial white background color. To avoid having sharp edges at borders of the newly-mapped pixels, a frame area represented by an inner frame and an outer frame may be blended as shown in FIG. 6.

FIG. 6 illustrates an example blending of a camera image with the panoramic image. As illustrated, the area between the outer blending frame 606 and the inner blending frame 604 may be blended with the panoramic image 402. In one embodiment, the pixels may be blended linearly. However, other approaches may also be used in pixel blending without departing from teachings of the present disclosure. Pixels that are located at the border of the image (outer frame 606) may be taken from the panoramic map. A blending operation may be used in the area between the inner 604 and outer 606 frames along the direction of the normal to the outer frame. The region inside the inner blending frame 604 may be mapped directly from the camera image. To avoid blending the frame with unmapped white background color, new pixels are mapped directly from the camera image without blending.

The following example pseudo-code represents the blending algorithm, where x and y are coordinates of the camera image, frame Width represents width of the blending frame, camColor and panoColor represent colors of the respective pixels of the camera and panoramic image and alphaFactor represents the blending factor:

Input: a fragment from the camera image frame
if fragment in blending frame) then

if alreadyMapped == TRUE) then
minX = x > frameWidth ? camWidth − x : x;
minY = y > frameWidth ? camHeight − y : y;
alphaFactor = minX < minY ? minX/frameWidth :
minY/frameWidth;
newColor.r = camColor.r*alphaFactor +
panoColor.r*(1.00−alphaFactor);
newColor.g = camColor.g*alphaFactor +
panoColor.g*(1.00−alphaFactor);
newColor.b = camColor.b*alphaFactor +
panoColor.b*(1.00−alphaFactor);
else
color = camColor;
end if

else

color = camColor;

end if

In this example, two frame-buffers (e.g., two copies of the panorama image) are used that change roles for each frame. The panoColor and alreadyMapped are read from input texture, and the newColor is written to the output texture. The output texture may be used as an input to the next frame. Blending two images using a fragment shader is not a computationally intensive task and can easily be applied to the naive form of pixel mapping. However, in the pixel-blending, the whole area of the camera image is updated in every frame. Therefore, for certain embodiments, the blending operations can be combined with the brightness offset correction.

Mapping a panoramic image on a CPU may only be possible for medium-size panoramic images. However, CPU-based mapping will quickly meet its limits in computational power if resolution of the panoramic map and the camera image is increased. In contrast, the proposed mapping approach that can be performed on a parallel processor can handle larger texture sizes with a negligible loss in render speed.

It should be noted that in the proposed method, reducing the area that is passed to the fragment shader and/or size of the panoramic map does not have much influence on the real-time frame rates. On the other hand, size of the camera image has more influence on the real-time frame rate. As an example, the live preview feed of recent mobile phones (which is about 640×480 pixels) can still be rendered in real-time. Experimental results

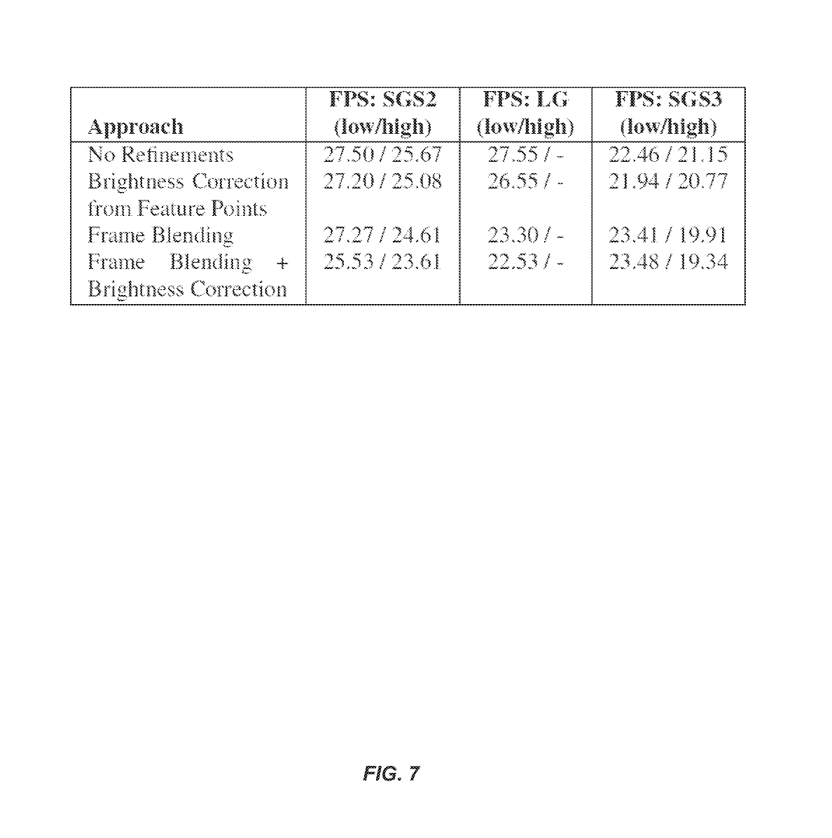

As an example, average rendering speed (e.g., number of frames per second) is calculated for different image refinement approaches as described herein. The results are illustrated in FIG. 7 for different approaches. In this table, the rendering speeds are shown for image refinement approaches such as no refinement (as a comparison point), brightness correction from feature points, frame blending, and a combination of the frame blending and brightness correction. For testing the speed differences for different panoramic mapping sizes, two resolutions are chosen. A lower and standard texture resolution of 2048×512 pixels and a higher texture resolution of 4096×1024 pixels are realized for this test. The tests are performed on three different testing devices:
Samsung Galaxy S II (SGS2): 1.2 GHz dual core; Mali-400 MP; Android 2.3.5
LG Optimus 4x HD (LG): 1.5 GHz quad core; Nvidia Tegra 3; Android 4.0.3
Samsung Galaxy S III (SGS3): 1.4 GHz quad core; Mali-400 MP; Android 4.0.3

FIG. 7 displays the render speed for the SGS2, the LG and the SGS3 for low resolution and high resolution panoramic images. Concerning the render speed for the standard resolution of 2048×512 pixels, all image refinement approaches run fluently with a frame rate higher than 20 frames per second (FPS). Similarly, rendering speed for the higher resolution panoramic image (4096×1024 pixels) is about 20 FPS or higher for all approaches.

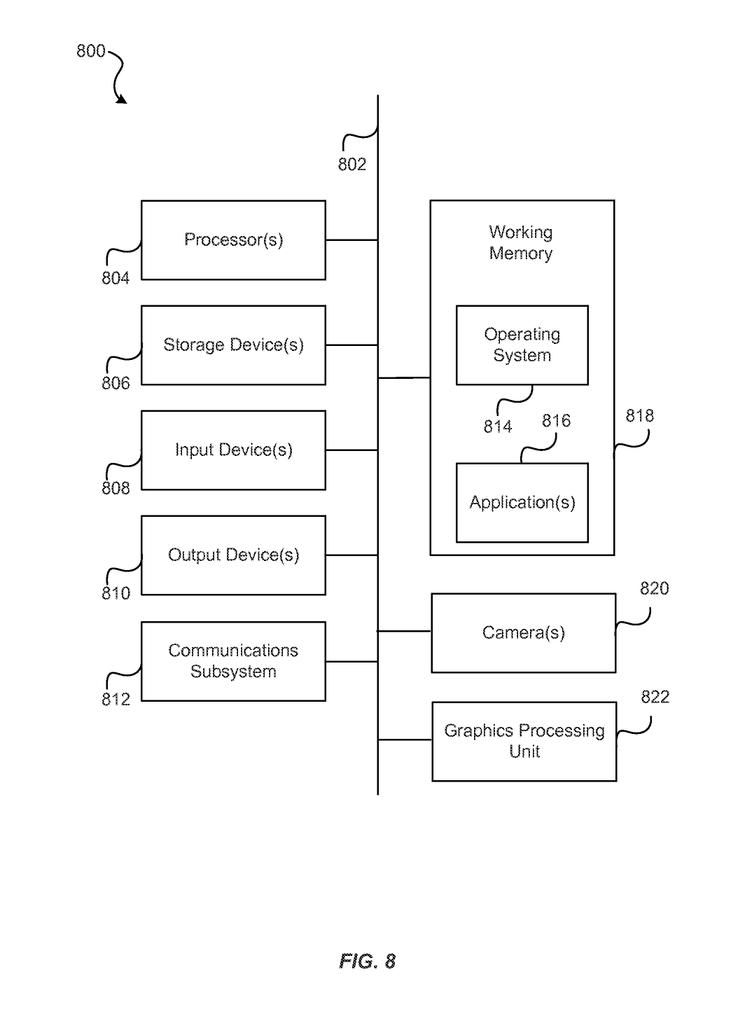

FIG. 8 illustrates an example of a computing system in which one or more embodiments may be implemented. A computer system as illustrated in FIG. 8 may be incorporated as part of the above described computerized device. For example, computer system 800 can represent some of the components of a camera, a television, a computing device, a server, a desktop, a workstation, a control or interaction system in an automobile, a tablet, a netbook or any other suitable computing system. A computing device may be any computing device with an image capture device or input sensory unit and a user output device. An image capture device or input sensory unit may be a camera device. A user output device may be a display unit. Examples of a computing device include but are not limited to video game consoles, head-mounted displays, tablets, smart phones and any other hand-held devices. FIG. 8 provides a schematic illustration of one embodiment of a computer system 800 that can perform the methods provided by various other embodiments, as described herein, and/or can function as the host computer system, a remote kiosk/terminal, a point-of-sale device, a telephonic or navigation or multimedia interface in an automobile, a computing device, a set-top box, a table computer and/or a computer system. FIG. 8 is meant only to provide a generalized illustration of various components, any or all of which may be utilized as appropriate. FIG. 8, therefore, broadly illustrates how individual system elements may be implemented in a relatively separated or relatively more integrated manner.

The computer system 800 is shown comprising hardware elements that can be electrically coupled via a bus 802 (or may otherwise be in communication, as appropriate). The hardware elements may include one or more processors 804, including without limitation one or more general-purpose processors and/or one or more special-purpose processors (such as digital signal processing chips, graphics processing units 822, and/or the like); one or more input devices 808, which can include without limitation one or more cameras, sensors, a mouse, a keyboard, a microphone configured to detect ultrasound or other sounds, and/or the like; and one or more output devices 810, which can include without limitation a display unit such as the device used in embodiments of the invention, a printer and/or the like. Additional cameras 820 may be employed for detection of user's extremities and gestures. In some implementations, input devices 808 may include one or more sensors such as infrared, depth, and/or ultrasound sensors. The graphics processing unit 822 may be used to carry out the method for real-time clearing and replacement of objects described above. Moreover, the GPU may perform panoramic mapping, blending and/or exposure time adjusting as described above.

In some implementations of the embodiments of the invention, various input devices 808 and output devices 810 may be embedded into interfaces such as display devices, tables, floors, walls, and window screens. Furthermore, input devices 808 and output devices 810 coupled to the processors may form multi-dimensional tracking systems.

The computer system 800 may further include (and/or be in communication with) one or more non-transitory storage devices 806, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 800 might also include a communications subsystem 812, which can include without limitation a modem, a network card (wireless or wired), an infrared communication device, a wireless communication device and/or chipset (such as a Bluetooth device, an 802.11 device, a WiFi device, a WiMax device, cellular communication facilities, etc.), and/or the like. The communications subsystem 812 may permit data to be exchanged with a network, other computer systems, and/or any other devices described herein. In many embodiments, the computer system 800 will further comprise a non-transitory working memory 818, which can include a RAM or ROM device, as described above.

The computer system 800 also can comprise software elements, shown as being currently located within the working memory 818, including an operating system 814, device drivers, executable libraries, and/or other code, such as one or more application programs 816, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods, including, for example, the methods described in FIG. 2 for real-time mapping and clearing of unwanted objects.

A set of these instructions and/or code might be stored on a computer-readable storage medium, such as the storage device(s) 806 described above. In some cases, the storage medium might be incorporated within a computer system, such as computer system 800. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which may be executable by the computer system 800 and/or might take the form of source and/or installable code, which, upon compilation and/or installation on the computer system 800 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some embodiments, one or more elements of the computer system 800 may be omitted or may be implemented separate from the illustrated system. For example, the processor 804 and/or other elements may be implemented separate from the input device 808. In one embodiment, the processor may be configured to receive images from one or more cameras that are separately implemented. In some embodiments, elements in addition to those illustrated in FIG. 8 may be included in the computer system 800.

Some embodiments may employ a computer system (such as the computer system 800) to perform methods in accordance with the disclosure. For example, some or all of the procedures of the described methods may be performed by the computer system 800 in response to processor 804 executing one or more sequences of one or more instructions (which might be incorporated into the operating system 814 and/or other code, such as an application program 816) contained in the working memory 818. Such instructions may be read into the working memory 818 from another computer-readable medium, such as one or more of the storage device(s) 806. Merely by way of example, execution of the sequences of instructions contained in the working memory 818 might cause the processor(s) 804 to perform one or more procedures of the methods described herein.

The terms “machine-readable medium” and “computer-readable medium,” as used herein, refer to any medium that participates in providing data that causes a machine to operate in a specific fashion. In some embodiments implemented using the computer system 800, various computer-readable media might be involved in providing instructions/code to processor(s) 804 for execution and/or might be used to store and/or carry such instructions/code (e.g., as signals). In many implementations, a computer-readable medium may be a physical and/or tangible storage medium. Such a medium may take many forms, including but not limited to, non-volatile media, volatile media, and transmission media. Non-volatile media include, for example, optical and/or magnetic disks, such as the storage device(s) 806. Volatile media include, without limitation, dynamic memory, such as the working memory 818. Transmission media include, without limitation, coaxial cables, copper wire and fiber optics, including the wires that comprise the bus 802, as well as the various components of the communications subsystem 812 (and/or the media by which the communications subsystem 812 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 804 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 800. These signals, which might be in the form of electromagnetic signals, acoustic signals, optical signals and/or the like, are all examples of carrier waves on which instructions can be encoded, in accordance with various embodiments of the invention.

The communications subsystem 812 (and/or components thereof) generally will receive the signals, and the bus 802 then might carry the signals (and/or the data, instructions, etc. carried by the signals) to the working memory 818, from which the processor(s) 804 retrieves and executes the instructions. The instructions received by the working memory 818 may optionally be stored on a non-transitory storage device 806 either before or after execution by the processor(s) 804.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Moreover, nothing disclosed herein is intended to be dedicated to the public.

What is claimed is:

1. A method for real-time processing of images, comprising:
constructing a panoramic image from a plurality of image frames while the plurality of image frames are being captured by at least one camera of a device;
identifying an area comprising unwanted portion of the panoramic image;
replacing a first set of pixels in the identified area with a second set of pixels from one or more of the plurality of image frames; and
storing the panoramic image in a memory.

2. The method of claim 1, wherein replacing the first set of pixels in the panoramic image comprises:
clearing the area in the panoramic image comprising the first set of pixels;
marking the area as unmapped within the panoramic image; and
replacing the unmapped area with the second set of pixels.

3. The method of claim 1, wherein identifying the area comprises:
analyzing the panoramic image to detect presence of at least one unwanted object within the panoramic image.

4. The method of claim 3, wherein analyzing the panoramic image further comprises executing a face detection algorithm on the panoramic image.

5. The method of claim 1, wherein the identifying and replacing steps are performed in real-time during construction of the panoramic image from the plurality of image frames.

6. The method of claim 1, wherein the panoramic image is constructed in a graphics processing unit.

7. The method of claim 1, further comprising:
correcting brightness offset of a plurality of pixels in the panoramic image while constructing the panoramic image.

8. The method of claim 7, wherein correcting brightness offset comprises:
defining an inner frame and an outer frame in the panoramic image; and
blending the plurality of pixels that are located between the inner frame and the outer frame.

9. An apparatus for real-time processing of images, comprising:
means for constructing a panoramic image from a plurality of image frames while the plurality of image frames are being captured by at least one camera of a device;
means for identifying an area comprising unwanted portion of the panoramic image;
means for replacing a first set of pixels in the identified area with a second set of pixels from one or more of the plurality of image frames; and
means for storing the panoramic image in a memory.

10. The apparatus of claim 9, wherein the means for replacing the first set of pixels in the panoramic image comprises:
means for clearing the area in the panoramic image comprising the first set of pixels;
means for marking the area as unmapped within the panoramic image; and
means for replacing the unmapped area with the second set of pixels.

11. The apparatus of claim 9, wherein the means for identifying the area comprises:
means for analyzing the panoramic image to detect presence of at least one unwanted object within the panoramic image.

12. The apparatus of claim 11, wherein the means for analyzing the panoramic image further comprises means for executing a face detection algorithm on the panoramic image.

13. The apparatus of claim 9, wherein the means for identifying and means for replacing steps operate in real-time during construction of the panoramic image from the plurality of image frames.

14. The apparatus of claim 9, further comprising:
means for correcting brightness offset of a plurality of pixels in the panoramic image while constructing the panoramic image.

15. The apparatus of claim 14, wherein means for correcting brightness offset comprises:
means for defining an inner frame and an outer frame in the panoramic image; and
means for blending the plurality of pixels that are located between the inner frame and the outer frame.

16. An apparatus for real-time processing of images, comprising:
at least one processor configured to:
construct a panoramic image from a plurality of image frames while the plurality of image frames are being captured by at least one camera of a device;
identify an area comprising unwanted portion of the panoramic image;
replace a first set of pixels in the identified area with a second set of pixels from one or more of the plurality of image frames; and
store the panoramic image in a memory, wherein the memory is coupled to the at least one processor.

17. The apparatus of claim 16, wherein the processor is further configured to:
clear the area in the panoramic image comprising the first set of pixels;
mark the area as unmapped within the panoramic image; and
replace the unmapped area with the second set of pixels.

18. The apparatus of claim 16, wherein the processor configured to identify and replace the first set of pixels in real-time during construction of the panoramic image from the plurality of image frames.

19. The apparatus of claim 16, wherein the panoramic image is constructed in a graphics processing unit.

20. The apparatus of claim 16, wherein the processor is further configured to:
analyze the panoramic image to detect presence of at least one unwanted object within the panoramic image.
